(19) United States
(12) Patent Application Publication
(10) Pub. No.: US 2023/0152543 A1
(43) Pub. Date: May 18, 2023

(54) IMPULSE SIGNAL DETECTION FOR BURIED CABLE PROTECTION USING DISTRIBUTED FIBER OPTIC SENSING

(71) Applicant: NEC Laboratories America, Inc., Princeton, NJ (US)

(72) Inventors: Shaobo HAN, Princeton, NJ (US); Ming-Fang HUANG, Princeton, NJ (US); Yuheng CHEN, South Brunswick, NJ (US)

(73) Assignee: NEC LABORATORIES AMERICA, INC, Princeton, NJ (US)

(21) Appl. No.: 17/988,643

(22) Filed: Nov. 16, 2022

Related U.S. Application Data
(60) Provisional application No. 63/280,709, filed on Nov. 18, 2021.

(51) Int. Cl. G02B 6/44

(52) U.S. Cl. CPC G02B 6/443; G01K 11/32

(57) ABSTRACT

Disclosed are buried cable protection systems and methods that employ impulse signal detection by optical fiber sensing technologies, and which provide such protection automatically and in real-time. The methods theoretically model a time difference of arrival (TDoA) of an impulse wave travelling to a DFOS sensor fiber cable. A model employing a set of propagation relationships that account for vague knowledge about wave propagation speed and threat range(s) is fitted with parameters based on a numerical simulation—without specific knowledge of a source of vibration. As compared to vibration magnitude information, time of arrival (ToA) information is more consistent and less sensitive to ambiguities and inaccuracies. In addition, the model parameter can be adjusted adaptively when temporal resolution of the sensor changes or fluctuates. As a result, our inventive systems and methods effectively detect impulse signals from machines or other activities generating vibratory impulse ground events at different distances to a fiber optic cable and distinguish same from background noises including those caused by transportation modes such as train or vehicular traffic.

### CROSS REFERENCE

This application claims the benefit of U.S. Provisional Patent Application Ser. No. 63/280,709 filed 18 Nov. 2021 the entire contents of which being incorporated by reference as if set forth at length herein.

### TECHNICAL FIELD

This disclosure relates generally to distributed fiber optic sensing (DFOS) systems, methods, and structures. More particularly, it discloses impulse signal detection for buried cable protection using distributed fiber optic sensing.

### BACKGROUND

As is known, construction activity—and in particular digging and/or excavating activities—oftentimes pose a serious threat of damage to deployed underground utilities including optical fiber telecommunications facilities. Without careful monitoring and timely intervention, such activities can produce unexpected network/communications outages for many thousands of customers. Oftentimes, such activities that may threaten such underground utilities may produce detectable impulse events.

Distributed fiber optic sensing and its variants including distributed vibration sensing and distributed acoustic sensing have found widespread applicability in several contemporary applications including infrastructure monitoring, security—intrusion detection, traffic monitoring, strain and temperature measurement—among others. Impulse events—which generate mechanical waves (vibrations) propagating in soil medium can be sensed by DFOS techniques. However, DFOS systems are sensitive to many kinds of vibrations and it is quite difficult to differentiate facility-threatening vibratory events from non-threatening ones.

### SUMMARY

An advance in the art is made according to aspects of the present disclosure directed to buried cable protection systems and methods that employ impulse signal detection by optical fiber sensing technologies, and which provide such protection automatically and in real-time.

Viewed from one aspect, our inventive methods theoretically model a time difference of arrival (TDoA) of an impulse wave travelling to a DFOS sensor fiber cable. A model employing a set of propagation relationships that account for vague knowledge about wave propagation speed and threat range(s) is fitted with parameters based on a numerical simulation—without specific knowledge of a source of vibration. As compared to vibration magnitude information, time of arrival (ToA) information is more consistent and less sensitive to ambiguities and inaccuracies. In addition, the model parameter can be adjusted adaptively when temporal resolution of the sensor changes or fluctuates. As a result, our inventive systems and methods effectively detect impulse signals from machines or other activities generating vibratory impulse ground events at different distances to a fiber optic cable and distinguish same from background noises including those caused by transportation modes such as train or vehicular traffic.

Viewed from another aspect, our inventive systems and methods use DFOS and Artificial Intelligence (AI) techniques in an integrated manner for real-time monitoring along an entire optical fiber cable route. Lacking information about impulse sources, our inventive systems and methods utilize easier-to-obtain knowledge about the propagation medium (e.g., soil type, temperature, etc.) and how waves propagate therethrough (range of propagation speed), and after discretization with sensor configuration parameters (spatial and temporal resolutions), a specifically designed algorithm including important consensus parameters identified by simulation-to-real transfer on a lattice is employed.

A modified variant of progressive probabilistic Hough transform (PPHT), is customized for special types of waterfall image data having characteristics of sensing signals. As we have demonstrated during field trials, our systems and methods provide vibration detection and resulting protection for optical fiber cable routes having lengths of tens of kilometers with only a few seconds of latency.

### BRIEF DESCRIPTION OF THE DRAWING

A more complete understanding of the present disclosure may be realized by reference to the accompanying drawing in which:

FIG. 1 is a schematic diagram showing an illustrative DFOS system according to aspects of the present disclosure;

FIG. 2 is a schematic flow chart illustrating intelligent fiber sensing based cable protection according to aspects of the present disclosure;

FIG. 3 is a schematic diagram showing an illustrative wave propagation model according to aspects of the present disclosure;

FIG. 4 is a schematic diagram showing an illustrative system layout of a sensing layer on existing deployed optical fiber according to aspects of the present disclosure;

FIG. 5 is a plot showing illustrative groups of TDoA curves simulated with 5 different propagation speeds and 4 different source-to-cable distances and within each group, the curves are approximated by a least square linear regression curve with coefficient of determination close to 1, according to aspects of the present disclosure;

FIG. 6 is a schematic diagram showing illustrative procedures to infer parameters later used for impulse event detection in which the fitted parameters account for both the ambiguity in source and medium and the discretization error of the DFOS sensor according to aspects of the present disclosure;

FIG. 7 is a schematic diagram showing illustrative pipeline of impulse event detector according to aspects of the present disclosure; and

FIG. 8 is a schematic diagram showing illustrative components of methods according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we begin by noting that distributed fiber optic sensing (DFOS) is an important and widely used technology to detect environmental conditions (such as temperature, vibration, acoustic excitation vibration, stretch level etc.) anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. DFOS can also employ a signal of forward direction that uses speed differences of multiple modes. Without losing generality, the following description assumes reflected signal though the same approaches can be applied to forwarded signal as well.

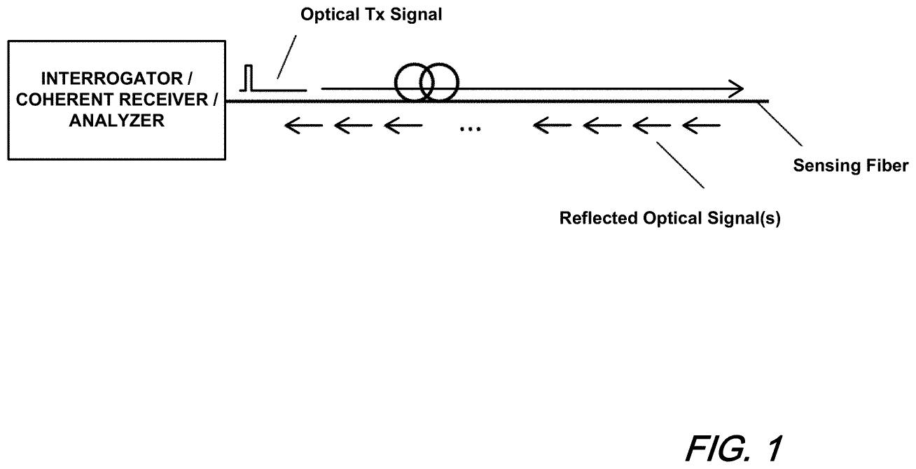

FIG. 1 is a schematic diagram of a generalized, DFOS system. As will be appreciated, a contemporary DFOS system includes an interrogator that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The reflected signal carries information the interrogator uses to detect, such as a power level change that indicates—for example—a mechanical vibration. While not shown in detail, the interrogator may include a coded DFOS system that may employ a coherent receiver arrangement.

The reflected signal is converted to electrical domain and processed inside the interrogator. Based on the pulse injection time and the time signal is detected, the interrogator determines at which location along the fiber the signal is coming from, thus able to sense the activity of each location along the fiber.

Those skilled in the art will understand and appreciate that by implementing a signal coding on the interrogation signal enables the sending of more optical power into the fiber which can advantageously improve signal-to-noise ratio (SNR) of Rayleigh-scattering based system (e.g. distributed acoustic sensing (DAS) or distributed vibration sensing (DVS)) and Brillouin-scattering based system (e.g. Brillouin optical time domain reflectometry or BOTDR).

As currently implemented in many contemporary implementations, dedicated fibers are assigned to DFOS systems in fiber-optic cables—physically separated from existing optical communication signals which are conveyed in different fiber(s). However, given the explosively growing bandwidth demands, it is becoming much more difficult to economically operate and maintain optical fibers for DFOS operations only. Consequently, there exists an increasing interest in integrating communications systems and sensing systems on a common fiber that may be part of a larger, multi-fiber cable or a common fiber that simultaneously carries live telecommunications traffic in addition to the DFOS data.

Operationally, we assume that the DFOS system will be Rayleigh-scattering based system (e.g., distributed acoustic sensing or distributed vibration sensing) and Brillouin-scattering based system (e.g., Brillouin optical time domain reflectometry or BOTDR) and may include a coding implementation. With such coding designs, such systems will be most likely be integrated with fiber communication systems due to their lower power operation and will also be more affected by the optical amplifier response time.

Advantageously, the DFOS operation may also be integrated together with communication channels via WDM in the same fiber. Inside the sensing fiber, the interrogation sequence and the returned sensing signal may be optically amplified—either via discrete (EDFA/SOA) or distributed (Raman) methods. A returned sensing signal is routed to a coherent receiver after amplification and optical band-pass filtering. The coherent receiver detects the optical fields in both polarizations of the signal, down-converting them to 4 baseband lanes for analog-to-digital conversion (ADC) sampling and digital signal processor (DSP) processing. As those skilled in the art will readily understand and appreciate, the decoding operation is done in the DSP to generate the interrogated Rayleigh or Brillouin response of the fiber, and any changes in the response are then identified and interpreted for sensor readouts.

With such configurations, since the coded interrogation sequence is generated digitally, the out-of-band signal is also generated digitally, and then combined with the code sequence before waveforms are created by a DAC. When generated together digitally, the out-of-band signal will only be generated outside a time period of the code sequence, so when added together, the combined waveform will have a constant amplitude.

As those skilled in the art will understand and appreciate, DFOS/DAS/DVS systems have been shown to detect, record and listen to acoustic vibrations in the audible frequency range.

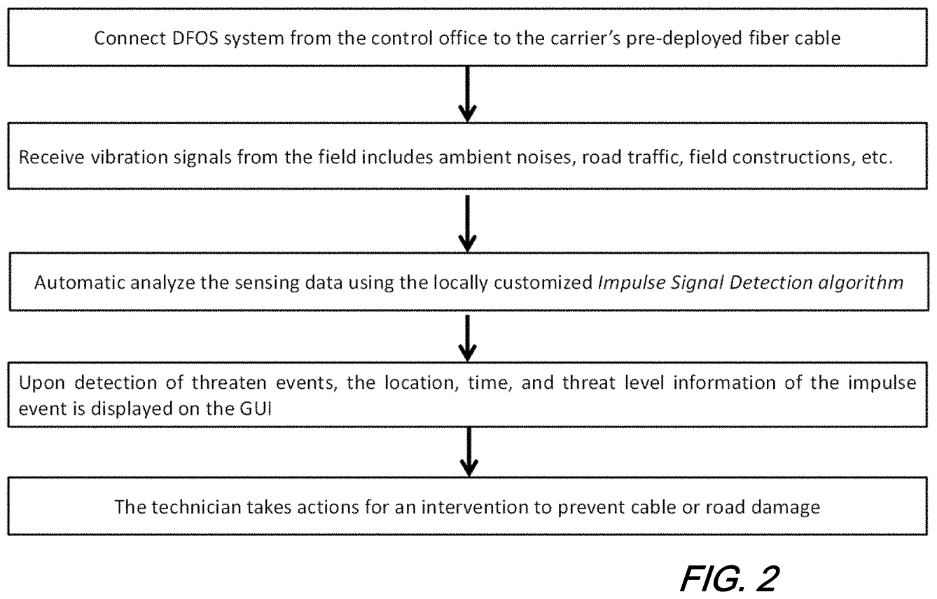

FIG. 2 is a schematic flow chart illustrating intelligent fiber sensing based cable protection according to aspects of the present disclosure.

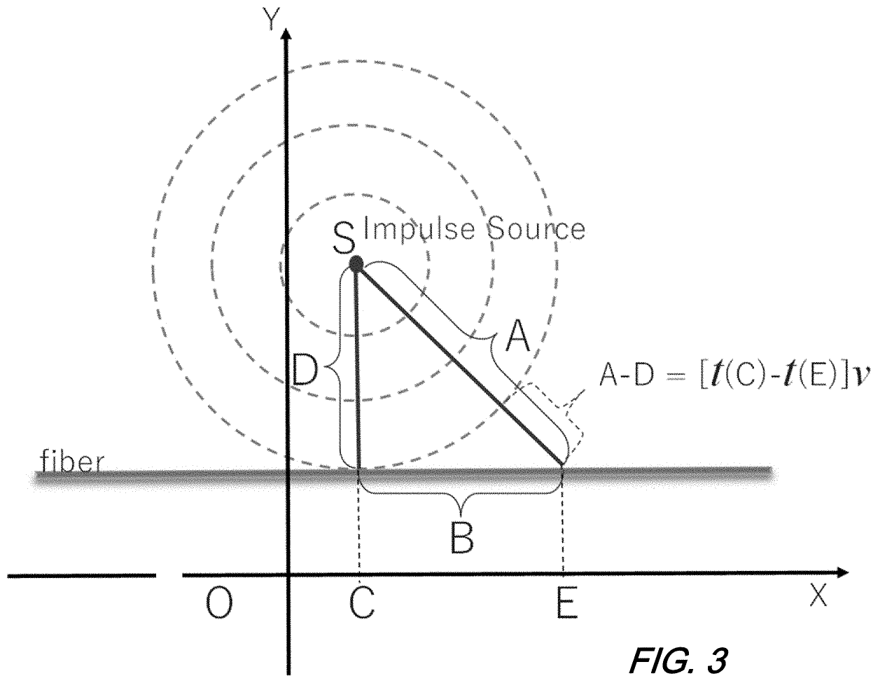

FIG. 3 is a schematic diagram showing an illustrative wave propagation model according to aspects of the present disclosure for a vibratory impulse generated by impulse source that vibrates/excites fiber optic sensor cable. As illustrated in that figure, S is the location of the impulse signal source; C is the closest point on the fiber optic cable to the impulse source; D is the closest distance from the impulse source S to the fiber optic cable; E is a point (different from C) on the fiber optic cable within an influence range; B is the fiber optic cable distance between cable point C and cable point E; A is the distance from the impulse source to the cable point E; v is the wave propagation speed; t(C) is the time when wave arrives at cable point C; and t(E) is the time when wave arrives at cable point E.

Since the distances from a signal source to different cable points are different, there is a difference in time of arrival (ToA) for waves propagated in different directions. From the simplified wave propagation model shown in FIG. 2, it is noted that a TDoA between two cable points E and C follows the equation,

Δt(E, C)=(\sqrt{B²+D²}−D)/v

where B is a known parameter from the the DFOS system, D is the source-to-cable distances that can take a range (e.g., 4 to 10 meters depending on the cable depth), v is influenced by the soil type and the temperature, which in most cases is only vaguely known (e.g., 140 m/s to 220 m/s). Evaluating on multiple sensing points, a theoretical curve of TDoA can be obtained.

We note that it is quite difficult to manually determine from waterfall images an exact time of arrival. Accordingly, our inventive systems and methods are designed to detect impulse events automatically from the waterfall images, using the TDoA with parameters inferred from additional knowledge that are either exactly or inexactly known.

Step 0: Simulate TDoA Curves Based on Different Speed and Source-to-Cable Distance Parameters

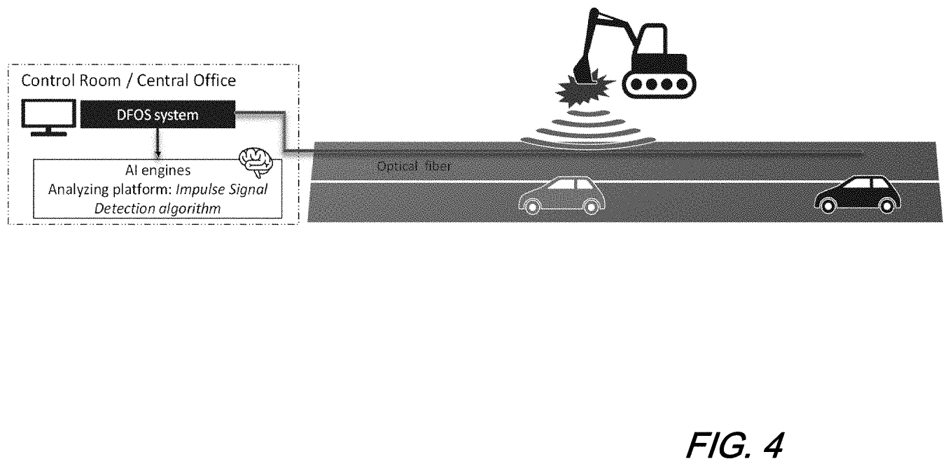

FIG. 4 is a schematic diagram showing an illustrative system layout of a distributed fiber optic sensing deployed on existing deployed optical fiber according to aspects of the present disclosure. The distributed fiber optic sensing system (DFOS)—which can be distributed acoustic sensing (DAS) and/or distributed vibration sensing (DVS)—is primarily located in a control office/central office for remote monitoring of an entire optical fiber cable route. The DFOS system is connected to the optical sensing fiber to provide sensing functions. The fiber can be a dark fiber or operational fiber from service providers in which it simultaneously carries telecommunications traffic.

Step 1: Simulate TDoA Curves Based on Different Speed and Source-to-Cable Distance Parameters

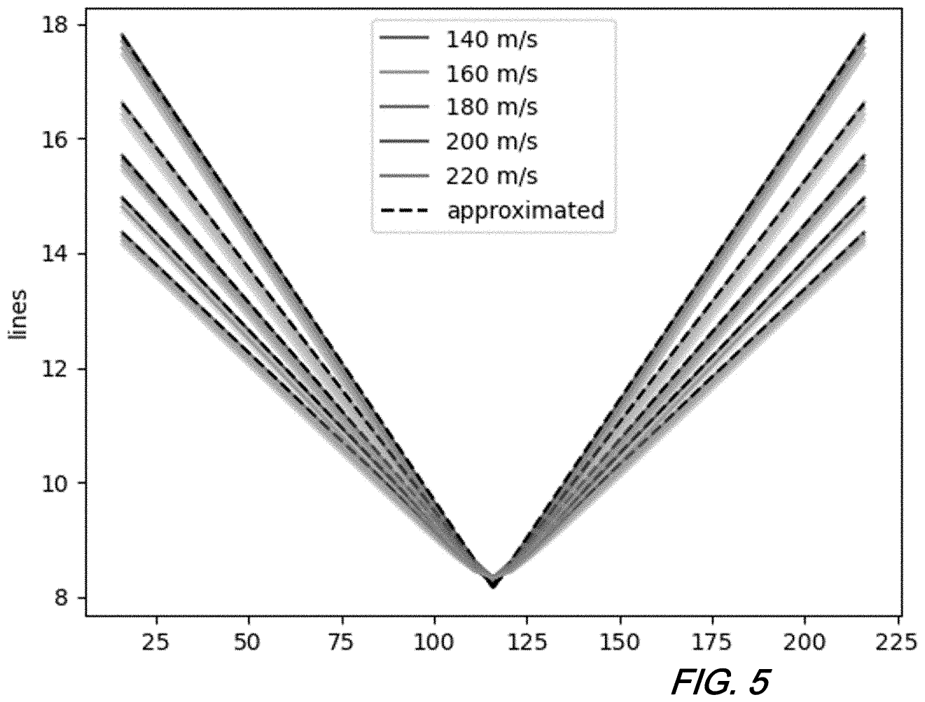

We assume the propagation medium is locally homogeneous with an unknown constant speed v. Depending on the prior knowledge, the user may specify a range of possible wave propagation speeds. Meanwhile, the threaten source-to-cable distance can also be a ranged variable. The ideal TDoA curves under a few different settings are simulated in FIG. 5 is a plot showing illustrative groups of TDoA curves simulated with 5 different propagation speeds and 4 different source-to-cable distances and within each group, the curves are approximated by a least square linear regression curve with coefficient of determination close to 1, according to aspects of the present disclosure.

Step 2: Resolve the Ambiguities and Discretization Error with Least-Square Linear TDoA Curves Under each Sensor Setting

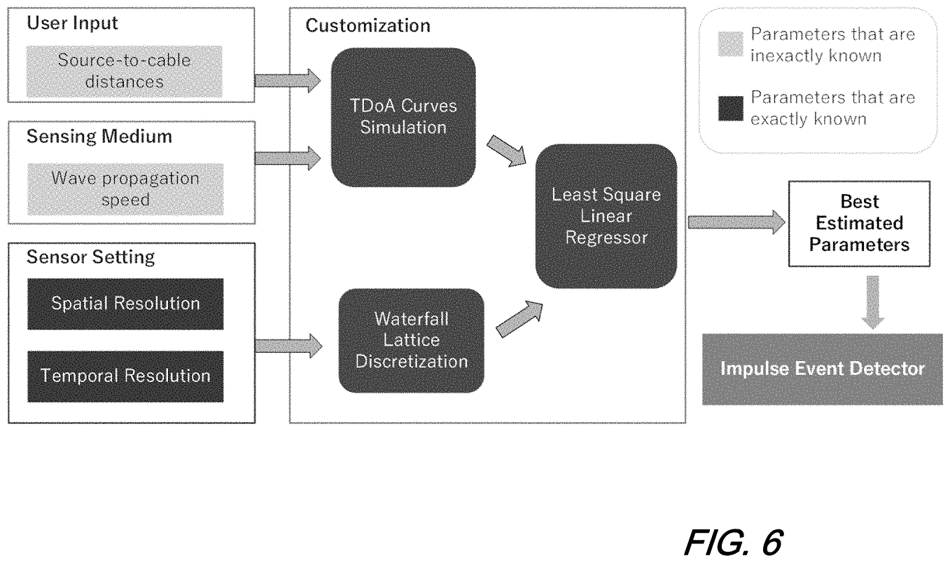

Given the spatial resolution and temporal resolution parameters of the DFOS system, the TDoA curves can be discretized on a lattice. Assuming propagation speed between 140 m/s and 220 m/s, and the source-to-cable distances range from 4 meters to 10 meters, the model parameters are identified via least square linear regression with R-square >0.998. FIG. 6 is a schematic diagram showing illustrative procedures to infer parameters later used for impulse event detection in which the fitted parameters account for both the ambiguity in source and medium and the discretization error of the DFOS sensor according to aspects of the present disclosure;

Step 3: Build a Customized Impulse Event Detector

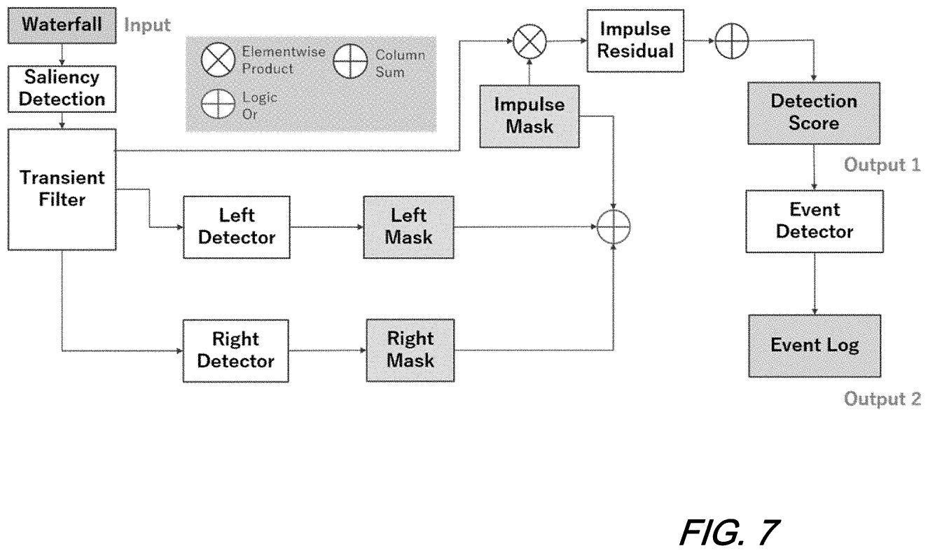

The identified model parameters reflect characteristics of the propagation medium (speed, cable depth, monitoring range), and the configuration of the DFOS system (temporal, spatial resolutions). Meanwhile, the linear model has been validated as a good approximation to both simulated curves and the real-world field data. Therefore, the progressive probabilistic Hough transform (PPHT) algorithm for line detection can be customized for detecting such events, with the parameter identified from the customization module in FIG. 6. FIG. 7 is a schematic diagram showing illustrative pipeline of impulse event detector according to aspects of the present disclosure. With reference to that figure, we note the following elements.

Input: DFOS waterfall data, customization parameter

Output:

Detection score: at each sensing point of the route, at each time point, computed as the total intensity of impulse events at each sensing location

Event log: for detected events with information such as location, time stamp, detection score, etc.

Modules:

Saliency detection: detect individual strongly vibrating points

Transient filter: filter out signals with duration longer than a few seconds

Left/Right detector: PPHT based detector using identified customization parameter

Left/Right mask: binary mask for the wave propagation on each direction

Impulse mask: a binary mask combining the left and right masks for detecting the whole impulse events

Event detector: only threatening impulse events occurred repeatedly for a small number of times are recorded to the event log.

As will be appreciated by those skilled in the art, our inventive system and method detects optical fiber cable-threatening impulse signals along a deployed buried optical fiber cable for cable safety protection. Different from aerial cable settings, detecting impulse events using the buried cable is more challenging, due to the complicated underground environment. By using distributed fiber optic sensing technology and a specially designed signal detector, automatic monitoring of the entire route for dangerous machine digging activities is enabled without the need of introducing third-party sensors. Upon detection, timely actions can be taken to prevent cable damage.

Machine digging activities impacting the ground generate impulse events. As the type of machine and the strength of impact force are hardly known, we describe a detector based on TDoA patterns that is less sensitive to these factors. However, it is still influenced by the interleaved factors of source-to-cable distances (including buried cable depth) and wave propagation speed. Moreover, the time lap and gap between sensing points can also make the results pattern look different. Instead of discarding this information, we employ a simulation-based approach to combat the inexactness of the knowledge about the sensing medium and inaccuracies of the sensor. Optimal parameters that are best suitable for each setting can be estimated, and it is transferable to the impulse event detector.

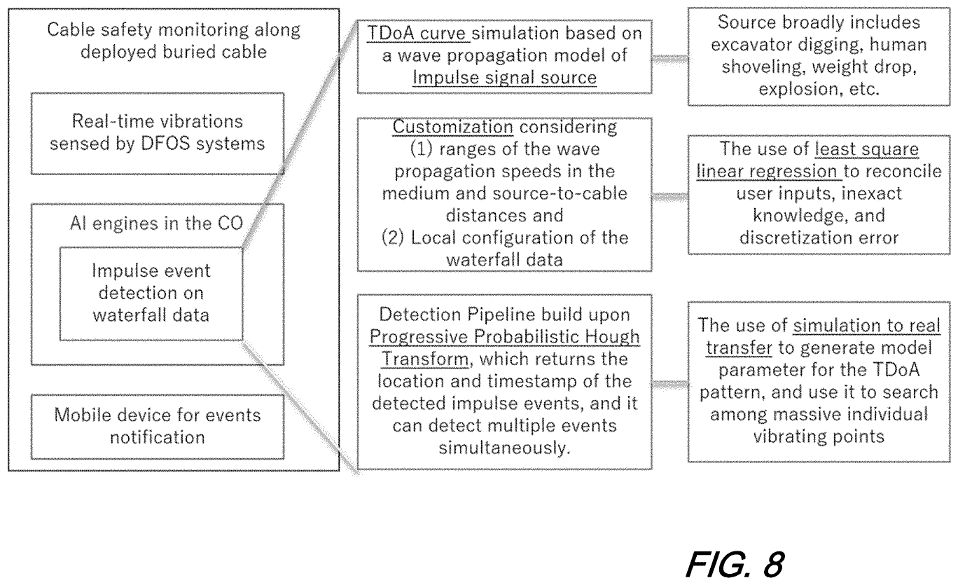

FIG. 8 is a schematic diagram showing illustrative components of methods according to aspects of the present disclosure.

At this point, while we have presented this disclosure using some specific examples, those skilled in the art will recognize that our teachings are not so limited. Accordingly, this disclosure should only be limited by the scope of the claims attached hereto.

1. An impulse signal detection method for buried cable protection using distributed fiber optic sensing (DFOS), said method comprising:
providing a DFOS system including
a length of optical sensor fiber, wherein said optical sensor fiber is field deployed as part of an optical fiber cable;
a DFOS interrogator in optical communication with the optical sensor fiber, said DFOS interrogator configured to generate optical pulses, introduce the generated pulses into the length of optical sensor fiber, and receive backscattered signals from the length of the optical sensor fiber; and
an intelligent analyzer configured to analyze colorless DFOS/DVS data received by the DFOS/DVS interrogator and determine from the backscattered signals, vibrational activity occurring at locations along the length of the optical sensor fiber;
generate groups of time difference of arrival (TDoA) curves based on different speed and different vibration source-to-optical fiber cable parameters;
resolve any ambiguities and discretization errors in the generated groups of TDoA curves and identify model parameters using least square linear regression with an R-square >0.998;
construct a customized impulse signal event detector and detect impulse events using a progressive probabilistic Hough transform (PPHT); and
outputting an indicium of the detected impulse events.

2. The method of claim 1 further comprising outputting a detection score of each sensing point along the length of the sensing fiber, computed as a total intensity of impulse events at each sensing location.

3. The method of claim 2 further comprising outputting an event log of detected events including location, time stamp, and detection score.

4. The method of claim 3 wherein the impulse signal event detector is configured to receive as input DFOS waterfall data and customization parameters and detect individual vibrating points along the length of the sensor fiber.

5. The method of claim 4 wherein the impulse signal event detector is configured to filter out signals having durations exceeding a pre-determined threshold duration.

6. The method of claim 5 wherein the impulse signal event detector is configured to perform the PPHT and mask its output for wave propagation in multiple (Left/Right) directions.

7. The method of claim 5 wherein the impulse signal event detector is configured to combine the multiple (Left/Right) directions for detecting whole impulse events.

8. The method of claim 7 wherein the impulse signal event detector is further configured to detect threatening impulse events.
